(19) United States
(12) Patent Application Publication
(10) Pub. No.: US 2011/0155146 A1
(43) Pub. Date: Jun. 30, 2011

(54) MOUTHPIECE AND RELATED SYSTEMS AND METHODS

(76) Inventor: DAVID C. MARSH, Winston-Salem, NC (US)

(21) Appl. No.: 12/951,407

(22) Filed: Nov. 22, 2010

Related U.S. Application Data
(60) Provisional application No. 61/284,989, filed on Dec. 31, 2009.

(51) Int. Cl. A61C 5/14; A42B 1/24; A41D 19/00; A41D 13/00

(52) U.S. Cl. 128/861; 2/422; 2/160; 2/69

(57) ABSTRACT

Mouthpiece retention systems and methods are shown and described. In one example, a mouthpiece includes a guard shaped to fit in a wearer's mouth and a magnet. In other examples, the mouthpiece includes a semi-rigid grip having a proximate end attached to the guard and a distal end securing the magnet. A method of releasably fastening the mouthpiece includes removing the mouthpiece from the wearer's mouth and positioning the magnet end of the mouthpiece on an athletic uniform to create a coupling position.

### FIELD

The present disclosure relates generally to athletic activity protection, and more particularly to improved mouthpiece and retention systems.

### BACKGROUND

Mouthpieces are often used to prevent bodily injury to users and participants in athletic events, such as football, soccer, hockey, lacrosse and the like. In fact, in certain athletic events, an athlete must wear a protective mouth guard to participate in the event. During the course of the event, however, a user will often temporarily remove the mouthpiece, for example during times of athletic inactivity. When the mouthpiece is temporarily removed, the mouthpiece may become lost or contaminated.

To avoid many of these problems, mouthpieces have been designed with flexible attachment cords or straps. Often, the attachment strap secures the mouthpieces to a user, for example on the athlete's helmet. However, there are several safety and other concerns with the attachment strap design. For example, bodily damage may occur from exertion by a pulling force on the strap. For instance, the impact may be transmitted generally along a path substantially in alignment with the point of attachment, for example at the user's teeth. Other problems include broken or ripped straps that require additional monitoring and maintenance.

Therefore, Applicant desires improved mouthpieces and methods for retaining mouthpieces without many of the drawbacks presented by the cords and straps of traditional mouthpiece retention systems.

### SUMMARY

By way of summary, the current disclosure is directed to a variety of mouthpieces for releasably fastening to a binding surface of an athletic uniform to create a coupling position. Athletic uniforms used with the mouthpiece may vary. For example, they may include at least one of a helmet, a faceguard, a crossbar, a metallic strip on or within clothing or the like. Binding surfaces of athletic uniforms may similarly vary. For example, with a helmet, the binding surface may be the face guard or a metallic portion on the helmet. In some examples, e.g., with a soccer jersey, the binding surface may be a metal strip (also intended to be inclusive of magnets) positioned within the fabric, e.g., contained within a small pocket on the shoulder of the jersey.

As noted, mouthpieces are configured to releasably fasten to the binding surface and a variety of mouthpiece configurations may be used. In one example, a mouthpiece includes a guard that shaped to fit in a wearer's mouth and a magnet having a magnetic strength sufficient to support the weight of the mouthpiece when in the coupling position. The magnet may be positioned in a variety of locations, e.g., on the distal end of the guard. The guard may include an inner peripheral sidewall and an outer peripheral sidewall, and the magnet may be embedded in the outer peripheral sidewall. In another example, the guard includes a grip, and the magnet may be positioned on the grip. In some examples, mouthpieces may include a plurality of magnets.

The current disclosure is also directed to methods related to the mouthpiece, for example, methods of releasably fastening a mouthpiece having a magnet to an athletic uniform. In one example, a method includes positioning the mouthpiece in a wearer's mouth, removing the mouthpiece from the wearer's mouth, for example by the guard or by the grip, and positioning the magnet end on the athletic uniform to create a coupling position.

In accordance with the present disclosure any of a variety of benefits may be realized. For example, at least one of the following, or additional benefits, may be realized: protecting an athlete, or similar wearer, from bodily injury while eliminating the need for carrying the mouthpiece in the athlete's hand during athletic inactivity; providing improved mouthpieces that are convenient, efficient, and safe for the user, particularly when used in combination with an athletic uniform having at least a metallic, or the like, surface portion; securing a mouthpiece during times of inactivity without the drawbacks of flexible cord/strap retention systems or squeezing the mouth guard into a portion of a helmet, etc.

The above summary was intended to briefly summarize a few examples of the present disclosure. Embodiments and examples will be set forth in more detail in the figures and description below. It will be apparent, however, that the description is not intended to limit the present invention, the scope of which should be properly determined by the appended claims.

### BRIEF DESCRIPTION OF THE DRAWINGS

The disclosure will be better understood by a reading of the Description of Embodiments along with a review of the drawings, in which:

FIG. 1 is a perspective view of a mouthpiece according to a first embodiment of the disclosure;

FIG. 2 illustrates the mouthpiece of FIG. 1, where the mouthpiece is shown in a coupling position with an athletic uniform;

FIG. 3 is a perspective view of a mouthpiece example according to a second embodiment of the disclosure;

FIG. 4 is a perspective view of another mouthpiece example according to the second embodiment;

FIG. 5 illustrates the mouthpiece of FIG. 3 in a coupling position;

FIG. 6 illustrates the mouthpiece of FIG. 4 in a coupling position;

FIG. 7 is a perspective view of another example of the mouthpiece;

FIG. 8 is a perspective view of another example of the mouthpiece; and

FIG. 9 is a perspective view of yet another example of the mouthpiece.

### DESCRIPTION OF EXEMPLARY EMBODIMENTS

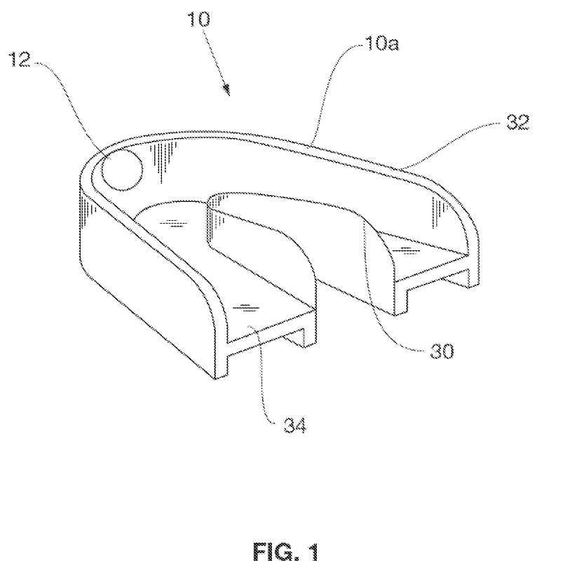

FIG. 1 illustrates mouthpiece 10, which is representative of one embodiment of a mouthpiece disclosed herein. In this example, mouthpiece 10 includes a guard 10a and magnet 12. Guard shape and structure may vary from example to example and embodiment to embodiment. In this example, guard 10a includes a U-shaped channel 34 defined by inner peripheral sidewall 30 and outer peripheral sidewall 32. Typically guards act as a teeth-receiving tray to protect the wearer's teeth and/or prevent tongue damage during physical activity.

In this example, U-shaped channel 34's outer surface tapers upwardly at its proximal ends. In other examples, inner peripheral sidewalls and outer peripheral sidewalls may define other saddle or horseshoe-shaped member sized for the convenience of its wearer. Further, other embodiments may include a tapered upper edge of inner peripheral wall and outer peripheral wall to improve the comfort fit for the user.

Guard 10a may be constructed from a variety of materials. For example, the guard may be a unitary structure molded from a compressible material of the type customarily employed in the manufacture of universal athletic mouth guards. Other embodiments of the guard include a variety of materials, styles, and sizes for the convenience and comfort fit of its wearer.

Magnet 12 may be positioned in a variety of places on the guard, for example on a distal end of the guard. In the example shown, magnet 12 is positioned centrally on the outer peripheral wall. Magnets may be secured in a variety of ways. For example, magnets may be embedded into a portion of the mouthpiece during the forming of the mouthpiece, may be mechanically embedded after the mouthpiece is formed, may be attached by adhesive, sonic welding, milling, etc. In other examples, magnets may extend outward from the mouthpiece.

Magnets commonly have a strength sufficient to support the weight of the mouthpiece when in the coupling position. For example, a magnet may have a magnetic strength sufficient to support mouthpieces weighing at least one of approximately 10 g, 12 g, 14 g, 16 g, and 20 g. Further, magnets may be selected to have a magnet strength sufficient to reduce inadvertent or unwanted release of the mouthpiece. For example, many examples will have a release strength in a range chosen from at least one of 40 to 300 g, 50 to 250 g, 60 to 200 g, and 100 to 175 g.

Magnets may be chosen from a variety of materials or constructions. For example, magnets may include ceramic or ferrite composites, e.g., made of a sintered composite of powdered iron oxide and carbonate ceramic. Other examples include magnets of neodymium iron born (NdFeB).

As shown in FIG. 1, mouthpiece 10 is generally configured to protect a wearer from bodily injury during athletic activity. However, it is within the spirit of this disclosure for mouthpiece 10 to be used in other non-athletic situations where risk of bodily injury, in particular dental injury, is apparent.

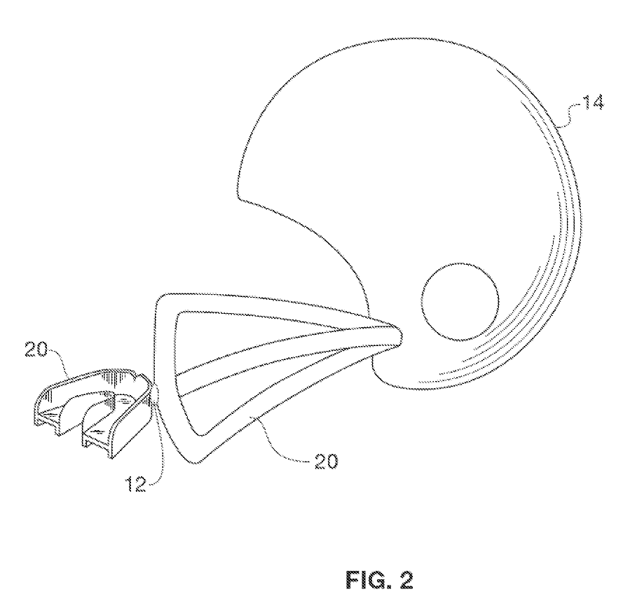

FIG. 2 illustrates mouthpiece 10 fastened to a binding surface 20 of an athletic uniform 20 to create the coupling position. In this example, the athletic uniform is a helmet, such as a football helmet, and the binding surface is a faceguard. Athletic uniforms and binding surfaces may vary. For example, athletic uniforms may include other protective gear, gloves or clothing, e.g. shirts, pants, shorts, jerseys, etc. Binding surfaces may similarly vary. For example, they may include other portions of a helmet or protective gear. For clothes and gloves, the binding surface may be an external metallic surface or may be a metallic surface covered by a material such as cloth. As noted, the binding surface may be another magnet. Some examples include combinations of covered and non-covered surfaces.

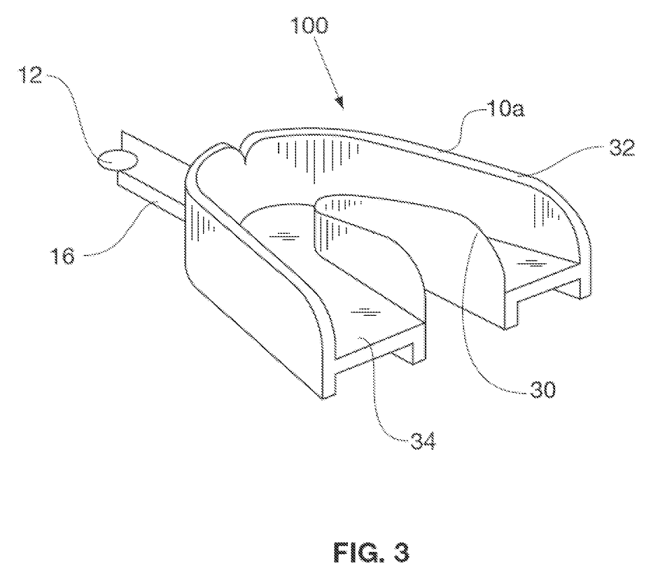

FIG. 3 illustrates mouthpiece 100, which is an example of a mouthpiece according to a second embodiment disclosed herein. In terms of general construction of guard 10a, mouthpiece 100 is similar to any of the examples described above. Mouthpiece 100 differs from mouthpiece 10 in that mouthpiece 100 includes grip 16 extending from guard 10a, with magnet 12 positioned on grip. Magnet 12 may be similar to any of the magnets described above, and may be attached to grip 16 using any of the methods described above.

Typically, grip 16 acts as an elongated retention stem to enable a wearer to handle mouthpiece 100 during periods of athletic inactivity. Grips may be constructed from a semi-rigid material, e.g., similar to the material used to construct the guard, and provide structure to structure to support the magnet in a substantially continuous position and/or allow a fixed structure for the wearer to grip and handle the mouthpiece. Grip 16 may also space a magnetic pull of magnet 12 away from the wearer when mouthpiece 100 is worn in the wearer's mouth. The proximate end of grip 16 is generally secured at the guard. In this example, the distal end of grip 16 secures magnet 12.

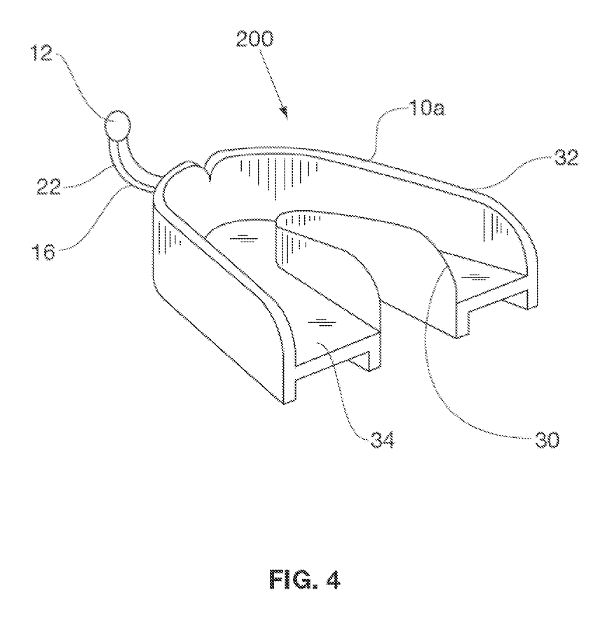

FIG. 4 shows mouthpiece 200, which is another example of the second embodiment. Mouthpiece 200, similar to mouthpiece 100, also includes protruding grip 16, however, grip 16 of mouthpiece 200 also includes support neck 22. In this example, support neck 22 includes about a ninety-degree bend to help space magnet 12 away from the user when worn in the wearer's mouth and to allow convenient handling. In other examples, support necks may include a variety of other bends and degree arrangements, such as about twenty-five degrees and about forty-five degrees, to allow convenient handling access and/or to help space the magnetic pull away from the wearer's mouth when the guard is inserted in the wearer's mouth.

Magnet size may vary from example to example. In typical examples, the magnet will be sized to be contained within the mouthpiece or a grip of the mouthpiece. Typical examples may range from 2-10 mm in length by 2-10 mm in width. Other examples may range from 3-6 mm in length by 3-6 mm in width. Magnets may also have a magnetic strength to retain any portion of the mouthpiece substantially perpendicular to the uniform surface when released by the wearer.

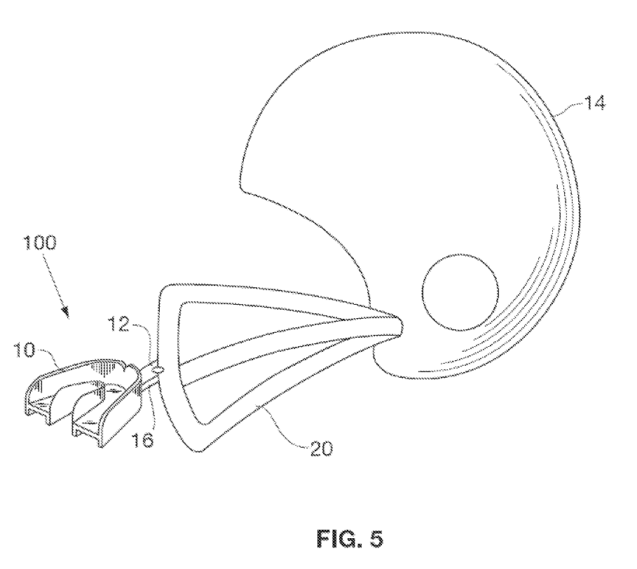

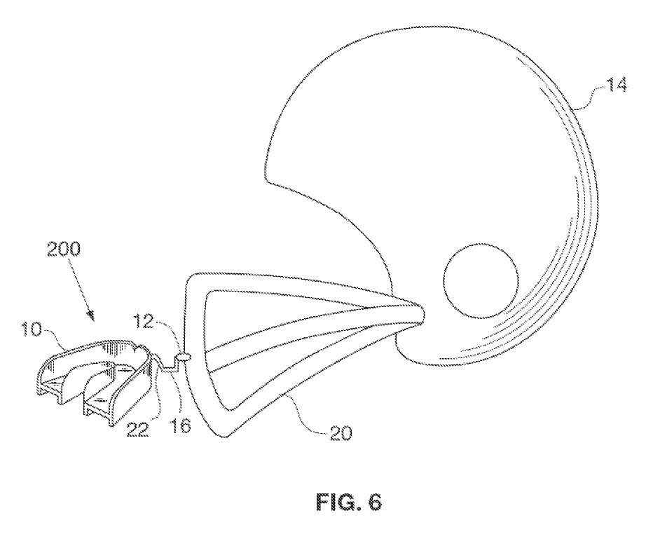

FIGS. 5 and 6 illustrate mouthpieces 100 and 200 in coupling positions.

In terms of use, during a period of athletic inactivity, a mouthpiece may be removed from the wearer's mouth, gym bag, hand or the like and generally positioned and released on the binding surface. In this coupling position, the magnet retains the mouthpiece in releasable contact with the uniform surface. For instance, the mouthpiece may be retained substantially perpendicular in uninterrupted contact with the metallic surface.

In the coupling position (for example a magnetic coupling position), the wearer may release the mouthpiece and the magnet will secure the mouthpiece in place for a releasable fastening. In some examples, magnets may be generally aligned between grip 16, or guard, so that a north-south orientation of the magnetic pull is perpendicular to the uniform's surface. In this embodiment, the coupling position may permit an uninterrupted contact between the magnet and the uniform surface until removed by the wearer.

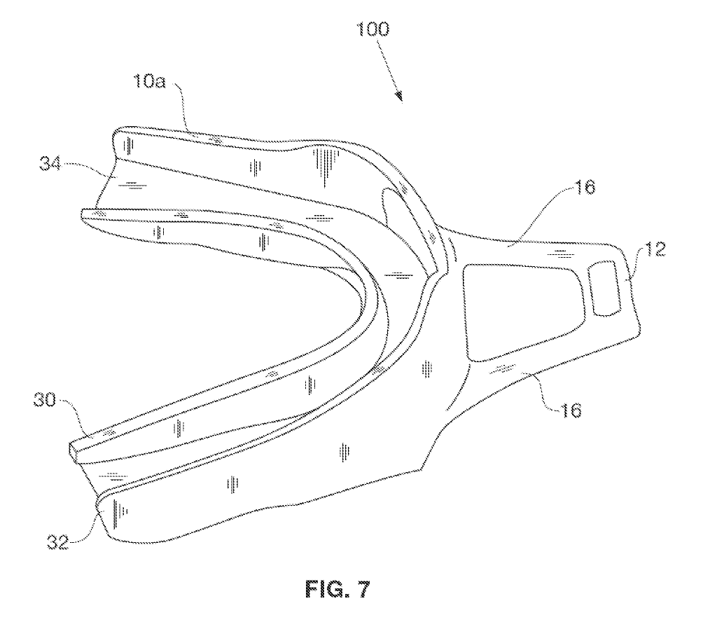

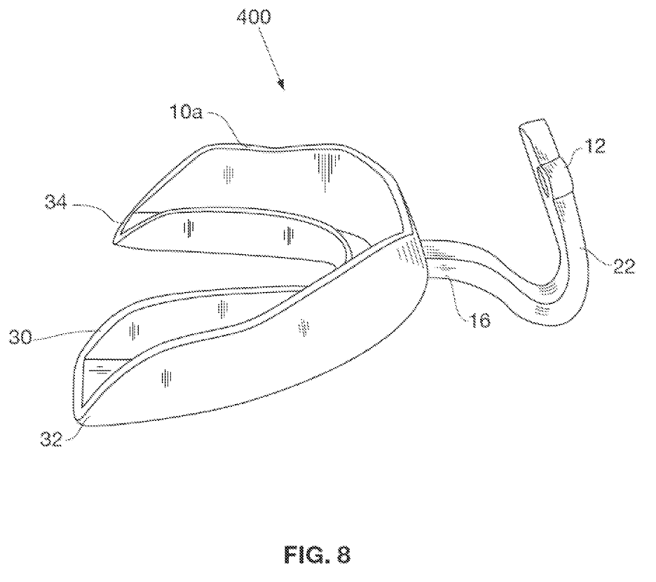

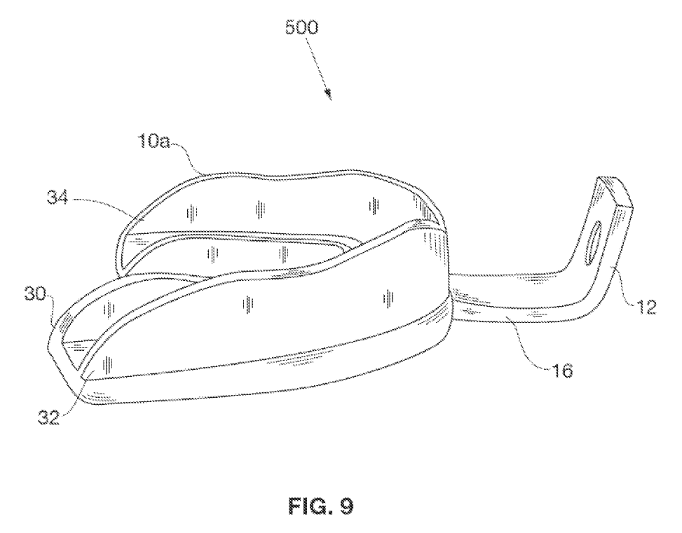

FIGS. 7-9 illustrate other examples of mouthpieces 300, 400 and 500, respectively, of the second embodiment. As shown in FIG. 7, the grip may include at least two members to connect the magnet and guard. Further, other examples may include a solid, or semi-solid, grip body, for example a grip body spanning between the at least two grip members introduced in FIG. 7.

In other embodiments, the disclosure includes a mouthpiece kit. In this embodiment, the kit may comprise a guard, e.g. any of the guards previously shown or described, and a magnet, e.g. any of the magnets shown or described. Most typically, each mouth guard is adapted to secure the magnet at the distal end or on a protruding grip, e.g. any of the styles or arrangements previously shown or described. In other embodiments, the kit may include a retrofit assembly including any of the elements previously shown or described for maintenance of the magnetic coupling force or to improve the comfort fit for the wearer.

Numerous characteristics and advantages have been set forth in the foregoing description, together with details of structure and function. The disclosure, however, is illustrative only, and changes may be made in detail, especially in matters of shape, size, and arrangement of parts, within the principle of the disclosure, to the full extent indicated by the broad general meaning of the terms in which the general claims are expressed. For example, a second, or plurality, of magnets may be included in any of styles and arrangements previously shown or described. It is further noted that, as used in this application, the singular forms “a,” “an,” and “the” include plural referents unless expressly and unequivocally limited to one referent.

We claim:

1. A mouthpiece for releasably fastening to a binding surface of an athletic uniform to create a coupling position, the mouthpiece comprising:
a guard shaped to fit in a wearer's mouth; and
a magnet positioned on the guard,
wherein the magnet has a magnetic strength sufficient to support the weight of the mouthpiece when in the coupling position.

2. The mouthpiece of claim 1, wherein the guard includes an inner peripheral sidewall and an outer peripheral sidewall.

3. The mouthpiece of claim 2, wherein the inner peripheral sidewall and the outer peripheral sidewall define a substantially U-shaped channel adapted for athletic activities.

4. The mouthpiece of claim 1, wherein the magnet is positioned on a distal end of the guard.

5. The mouthpiece of claim 2, wherein the magnet is positioned on a center of the outer peripheral sidewall.

6. The mouthpiece of claim 1, wherein the magnet is embedded on a distal end of the guard.

7. The mouthpiece of claim 1, wherein the athletic uniform is chosen from at least one of a helmet, a faceguard, a crossbar, clothing and a glove.

8. The mouthpiece of claim 1, wherein the magnet is chosen from a ceramic, a ferrite, a sintered composite of powdered iron oxide and carbonate ceramic.

9. The mouthpiece of claim 1, wherein the magnet is sized to fit within a portion of the guard.

10. The mouthpiece of claim 1, wherein a north-south orientation of the magnetic strength is perpendicular to the uniform's biding surface in the coupling position to permit uninterrupted contact between the magnet and the uniform surface.

11. The mouthpiece of claim 1, wherein the binding surface is a metallic portion.

12. The mouthpiece of claim 1, wherein the binding surface is a covered metallic portion.

13. The mouthpiece of claim 1, including a grip having a proximate end attached to the guard and a distal end securing the magnet.

14. The mouthpiece of claim 13, wherein the distal end of the grip extends the magnet away from the guard.

15. The mouthpiece of claim 13, wherein the distal end of the grip protrudes from the guard to space the magnet from the guard.

16. A mouthpiece for releasably fastening to a binding surface of an athletic uniform, the mouthpiece comprising:
a guard shaped to fit in a wearer's mouth;
a magnet; and
a semi-rigid grip having a proximate end attached to the guard and a distal end securing the magnet.

17. The mouthpiece of claim 16, wherein the grip is chosen from at least one of a co-planar extension from the guard and an angled neck from the guard.

18. The mouthpiece of claim 16, wherein the grip protrudes from the guard to allow the wearer to grip and handle the mouthpiece.

19. The mouthpiece of claim 16, wherein the magnet end of the grip includes a magnetic strength to retain the grip substantially perpendicular to the uniform surface in a magnetic coupling position when released by the wearer.

20. A mouthpiece for releasably fastening to a binding surface of an athletic uniform to create a coupling position, the mouthpiece comprising:
a guard weighing in the range of about 8 to about 16 g and shaped to fit in a wearer's mouth, the guard having an inner peripheral sidewall and an outer peripheral sidewall that define a substantially U-shaped channel adapted for athletic activities;
a magnet
having a length in the range of about 3 to about 6 mm, and width in the range of about 3 to about 6 mm, and
having a magnetic strength sufficient to support the weight of the mouthpiece when in the coupling position with a release strength in the range of about 50 to about 250 g; and
a semi-rigid grip having a proximate end attached to the guard and a distal end securing the magnet.
